(19) United States
(12) Patent Application Publication
(10) Pub. No.: US 2006/0251934 A1
(43) Pub. Date: Nov. 9, 2006

(54) High temperature fuel cell system with integrated heat exchanger network

(75) Inventors: Jeroen Valensa, Muskego, WI (US); Todd M. Bandhauer, Racine, WI (US); Michael J. Reinke, Franklin, WI (US); Swaminathan Venkataraman, Cupertino, CA (US)

Correspondence Address: FOLEY AND LARDNER LLP;SUITE 500, 3000 K STREET NW, WASHINGTON, DC, 20007, US

(73) Assignees: ION AMERICA CORPORATION; MODINE MANUFACTURING COMPANY

(21) Appl. No.: 11/124,120

(22) Filed: May 9, 2005

(51) Int. Cl. H01M 8/06; H01M 8/04

(52) U.S. Cl. 429/20; 429/26; 429/17

(57) ABSTRACT

A fuel cell system includes a fuel cell stack, a heat transfer device which is adapted to transfer heat from a cathode exhaust stream of the fuel cell stack to water to be provided to an fuel inlet stream, a reformer adapted to reform a hydrocarbon fuel to a hydrogen containing reaction product and to provide the reaction product to the fuel cell stack, and a combustor which is thermally integrated with the reformer.

### BACKGROUND OF THE INVENTION

The present invention is generally directed to fuel cells and more specifically to high temperature fuel cell systems and their operation.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

In a high temperature fuel cell system such as a solid oxide fuel cell (SOFC) system, an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

### BRIEF SUMMARY OF THE INVENTION

The preferred aspects of present invention provide a fuel cell system, comprising a fuel cell stack, a heat transfer device which is adapted to transfer heat from a cathode exhaust stream of the fuel cell stack to water to be provided to a fuel inlet stream, a reformer adapted to reform a hydrocarbon fuel to a hydrogen containing reaction product and to provide the reaction product to the fuel cell stack, and a combustor which is thermally integrated with the reformer.

### BRIEF DESCRIPTION OF THE DRAWINGS

FIG. 1 is a plot of temperature versus heat for fluid flow in a system of a comparative example.

FIGS. 2 and 3 are schematics of fuel cell systems according to the first preferred embodiment of the present invention. FIG. 2 is a system components and flow diagram and FIG. 3 shows the schematic of the heat exchanger network for the fuel cell system.

FIGS. 4, 5, 6 and 8 are plots of temperature versus heat for various fluid flows in systems of the preferred embodiments of the present invention.

FIG. 7 shows the schematic of the heat exchanger network for the fuel cell system of the third preferred embodiment of the present invention.

### DETAILED DESCRIPTION OF THE PREFERRED EMBODIMENTS

In order to maintain the SOFC at its elevated operating temperature, the anode and cathode flow streams exiting the fuel cell typically transfer heat to the incoming flows through a series of recuperative heat exchangers. In a comparative example, this can include the process of transferring heat to a liquid water source in order to generate steam for steam reforming of a hydrocarbon fuel in order to generate the hydrogen-rich reformate flow.

For example, the cathode heat may be recuperatively transferred from the cathode exhaust flow stream to the incoming cathode air, while the anode heat is partially recuperatively transferred from the anode exhaust to the incoming humidified fuel, such as natural gas, which feeds the steam reformer, and partially transferred to the water to generate the water vapor being provided into the fuel to humidify the fuel. In addition, the water vapor within the anode exhaust may be recaptured to serve either wholly or in part as the water source for the steam reformer.

The present inventors realized that a thermodynamic analysis of the system in which the anode (i.e., fuel side) exhaust stream is used to heat the humidified fuel and to evaporate the water reveals that there will be more energy available in the anode exhaust exiting the fuel cell than is required to be transferred to the incoming humidified fuel (i.e., water and fuel). However, a sizable portion of both the heat available in the anode exhaust and the heat required for the feed is in the form of latent heat. The result is that, while there is sufficient energy available in the anode exhaust, attempts to transfer the heat from the anode exhaust to the water and natural gas via a heat exchanger, in which the heat is transferred by convection from the anode exhaust stream to a thermally conductive surface separating the exhaust stream and one or more of the incoming fluids, and from said surface to the one or more of the incoming fluids, may not be commercially practical.

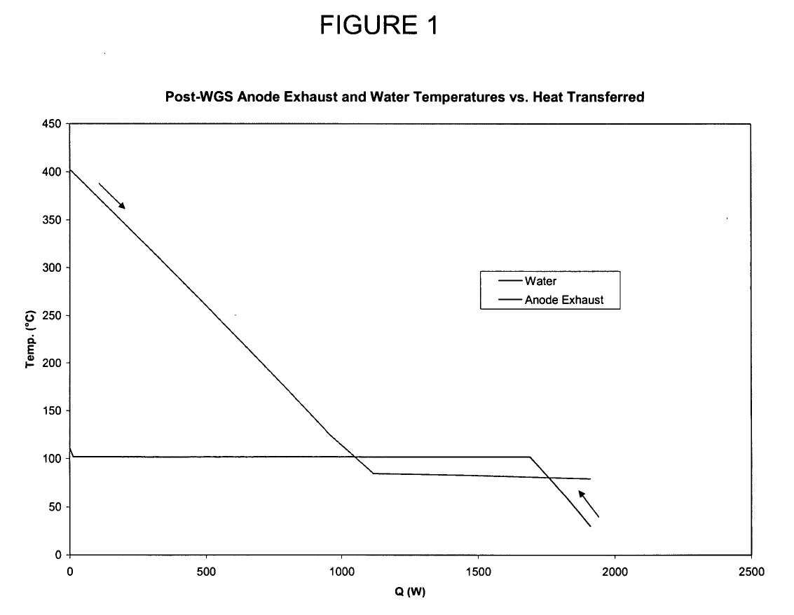

The above described problem is illustrated in FIG. 1, which shows the plot of temperature versus heat transferred for the anode exhaust and the water. The conditions in FIG. 1 assume a 400° C. anode exhaust temperature entering an evaporator (i.e., vaporizer) from a water-gas shift reactor, and a hypothetical counter flow evaporator capable of achieving full vaporization of the water, with minimal superheat.

As can be seen in FIG. 1, the condensing of water vapor from the fully saturated anode exhaust and the isothermal vaporization of the water causes the temperature of the heat rejecting anode exhaust to drop below the temperature of the heat receiving water for a substantial portion of the heat duty (i.e., the water curve is located above the anode exhaust curve for Q values of about 1,100 to about 1750 W). As a result, achieving the required heat transfer between the fluids solely by use of typical heat exchangers may not be feasible for the conditions assumed in FIG. 1, since the transfer of heat in a typical heat exchanger requires the temperature of the thermally conductive separating material to be less than the local bulk fluid temperature of the heat rejecting fluid, and higher than the local bulk fluid temperature of the heat receiving fluid.

Therefore, an additional heating source may be needed to evaporate sufficient water to satisfy the amount of steam required for methane reformation, which can be as high as 1.5 kW in a system with 6.5 kW electrical output. This additional heating source reduces system efficiency.

The present inventors realized that the cathode (i.e., air side) exhaust may be used to evaporate water being provided into the fuel and/or to heat the fuel being provided into the system. By using this alternative approach to the recapture of heat energy in the SOFC fuel cell system, the entire thermodynamic potential of the exhaust gases can be recaptured for preheating of the fuel cell feeds without mass transfer devices such as an enthalpy wheel, or additional heat sources. However, in some systems utilizing this alternative approach, it still may be desirable to utilize mass transfer devices such as an enthalpy wheel, or additional heat sources. The system where the cathode exhaust is used to vaporize water for humidifying the fuel and/or used to heat of incoming fuel is also be capable of being passively controlled. However, in some systems where the cathode exhaust is used to vaporize water for humidifying the fuel and/or used to heat incoming fuel, it may be desirable to utilize active control.

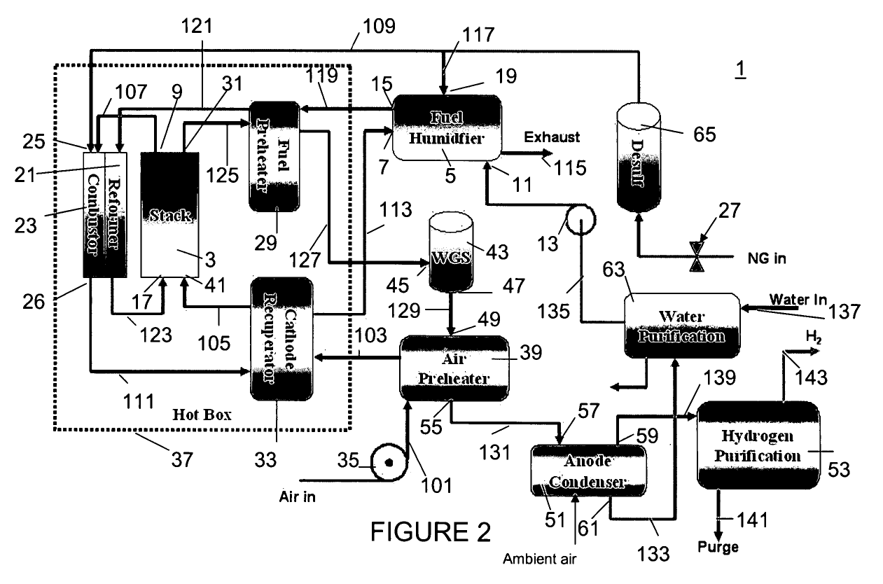

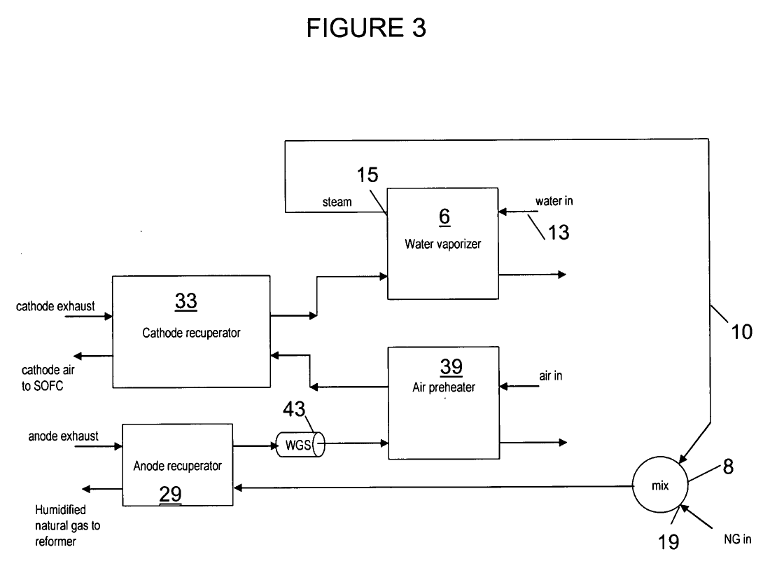

FIGS. 2 and 3 illustrate a fuel cell system 1 according to a first preferred embodiment of the invention. Preferably, the system 1 is a high temperature fuel cell stack system, such as a solid oxide fuel cell (SOFC) system or a molten carbonate fuel cell system. The system 1 may be a regenerative system, such as a solid oxide regenerative fuel cell (SORFC) system which operates in both fuel cell (i.e., discharge) and electrolysis (i.e., charge) modes or it may be a non-regenerative system which only operates in the fuel cell mode.

The system 1 contains one or more high temperature fuel cell stacks 3. The stack 3 may contain a plurality of SOFCs, SORFCs or molten carbonate fuel cells. Each fuel cell contains an electrolyte, an anode electrode on one side of the electrolyte in an anode chamber, a cathode electrode on the other side of the electrolyte in a cathode chamber, as well as other components, such as separator plates/electrical contacts, fuel cell housing and insulation. In a SOFC operating in the fuel cell mode, the oxidizer, such as air or oxygen gas, enters the cathode chamber, while the fuel, such as hydrogen or hydrocarbon fuel, enters the anode chamber. Any suitable fuel cell designs and component materials may be used.

The system 1 also contains a heat transfer device 5 labeled as a fuel humidifier in FIG. 2. The device 5 is adapted to transfer heat from a cathode exhaust of the fuel cell stack 3 to evaporate water to be provided to the fuel inlet stream and to also mix the fuel inlet stream with steam (i.e., the evaporated water). Preferably, the heat transfer device 5 contains a water evaporator (i.e., vaporizer) 6 which is adapted to evaporate water using the heat from the cathode exhaust stream. The evaporator 6 contains a first input 7 operatively connected to a cathode exhaust outlet 9 of the fuel cell stack 3, a second input 11 operatively connected to a water source 13, and a first output 15 operatively connected to a fuel inlet 17 of the stack 3. The heat transfer device 5 also contains a fuel-steam mixer 8 which mixes the steam or water vapor, provided into the mixer 8 from the first output 15 of the evaporator 6 through conduit 10, and the input fuel, such as methane or natural gas, provided from a fuel inlet 19, as shown in FIG. 3.

The term “operatively connected” means that components which are operatively connected may be directly or indirectly connected to each other. For example, two components may be directly connected to each other by a fluid (i.e., gas and/or liquid) conduit. Alternatively, two components may be indirectly connected to each other such that a fluid stream passes between the first component to the second component through one or more additional components of the system.

The system 1 also preferably contains a reformer 21 and a combustor 23. The reformer 21 is adapted to reform a hydrocarbon fuel to a hydrogen containing reaction product and to provide the reaction product to the fuel cell stack 3. The combustor 23 is preferably thermally integrated with the reformer 21 to provide heat to the reformer 21. The fuel cell stack 3 cathode exhaust outlet 9 is preferably operatively connected to an inlet 25 of the combustor 23. Furthermore, a hydrocarbon fuel source 27 is also operatively connected to the combustor 23 inlet 25.

The hydrocarbon fuel reformer 21 may be any suitable device which is capable of partially or wholly reforming a hydrocarbon fuel to form a carbon containing and free hydrogen containing fuel. For example, the fuel reformer 21 may be any suitable device which can reform a hydrocarbon gas into a gas mixture of free hydrogen and a carbon containing gas. For example, the fuel reformer 21 may reform a humidified biogas, such as natural gas, to form free hydrogen, carbon monoxide, carbon dioxide, water vapor and optionally a residual amount of unreformed biogas by a steam methane reformation (SMR) reaction. The free hydrogen and carbon monoxide are then provided into the fuel inlet 17 of the fuel cell stack 3. Preferably, the fuel reformer 21 is thermally integrated with the fuel cell stack 3 to support the endothermic reaction in the reformer 21 and to cool the stack 3. The term “thermally integrated” in this context means that the heat from the reaction in the fuel cell stack 3 drives the net endothermic fuel reformation in the fuel reformer 21. The fuel reformer 21 may be thermally integrated with the fuel cell stack 3 by placing the reformer and stack in the same hot box 37 and/or in thermal contact with each other, or by providing a thermal conduit or thermally conductive material which connects the stack to the reformer.

The combustor 23 provides a supplemental heat to the reformer 21 to carry out the SMR reaction during steady state operation. The combustor 23 may be any suitable burner which is thermally integrated with the reformer 21. The combustor 23 receives the hydrocarbon fuel, such as natural gas, and an oxidizer (i.e., air or other oxygen containing gas), such as the stack 3 cathode exhaust stream, through inlet 25. However, other sources of oxidizer besides the cathode exhaust stream may be provided into the combustor. The fuel and the cathode exhaust stream (i.e., hot air) are combusted in the combustor to generate heat for heating the reformer 21. The combustor outlet 26 is operatively connected to the inlet 7 of the heat transfer device 5 to provide the cathode exhaust mixed with the combusted fuel components from the combustor to the heat transfer device 5. While the illustrated system 1 utilizes a cathode exhaust flow in the heat transfer device 5 that has passed through a combustor, it may be desirable in some systems to utilize a cathode exhaust flow in the heat transfer device 5 that has not been passed through a combustor.

Preferably, the supplemental heat to the reformer 21 is provided from both the combustor 23 which is operating during steady state operation of the reformer (and not just during start-up) and from the cathode (i.e., air) exhaust stream of the stack 3. Most preferably, the combustor 23 is in direct contact with the reformer 21, and the stack 3 cathode exhaust is configured such that the cathode exhaust stream contacts the reformer 21 and/or wraps around the reformer 21 to facilitate additional heat transfer. This lowers the combustion heat requirement for SMR.

Preferably, the reformer 21 is sandwiched between the combustor 23 and one or more stacks 3 to assist heat transfer. When no heat is required by the reformer, the combustor unit acts as a heat exchanger. Thus, the same combustor 23 may be used in both start-up and steady-state operation of the system 1.

The system 1 also includes a fuel preheater heat exchanger (i.e., anode recuperator) 29 which is adapted to heat the fuel inlet stream using heat from the fuel cell stack 3 anode exhaust stream exiting from the stack 3 anode exhaust outlet 31. The system 1 further includes a cathode recuperator heat exchanger 33 which is adapted to heat an air inlet stream from an air blower 35 using heat from the cathode exhaust stream exiting the stack 3 cathode exhaust outlet 9. Preferably, the cathode exhaust stream mixed with the combusted fuel components from combustor 23 outlet 26 are provided into the cathode recuperator 33 to heat the air inlet stream. The cathode exhaust stream mixed with the combusted fuel components are then provided to the evaporator 6 of the heat transfer device 5 to evaporate the water to steam, which will then be provided into the fuel inlet stream heading into the reformer 21.

Preferably, the fuel cell stack 3, the reformer 21, the combustor 23, the fuel preheater heat exchanger 29 and the cathode recuperator heat exchanger 33 are located in a hot box 37. Preferably, the cathode recuperator heat exchanger 33 is intentionally undersized to ensure that the temperature of the cathode exhaust stream exiting the heat exchanger 33 is sufficiently high to allow the heat transfer device 5 to evaporate the water to steam via transfer of heat from the cathode exhaust stream. For example, in one embodiment, the cathode recuperator heat exchanger preferably has a size below a predetermined size, such that the cathode exhaust stream exits the cathode recuperator heat exchanger at a temperature of at least 200° C., such as 200° C. to 230° C., for example about 210° C. In this embodiment, the cathode exhaust stream may enter the cathode recuperator heat exchanger 33 at a temperature of at least 800° C., such as about 800° C. to about 850° C., for example about 820° C. The cathode recuperator heat exchanger 33 is intentionally undersized to have an exchange rate of about 10 to 12 kW, such as about 11 kW, for this embodiment. In contrast, a full sized heat exchanger may have an exchange rate of about 16 kW. While specific temperatures and heat exchange rates have been described for one embodiment, it should be understood that the exit and entrance temperatures and heat exchange rates will be highly dependent upon the particular parameters of each specific application, and accordingly, it should be understood that no limitations to specific exit and entrance temperatures or heat exchange rates are intended unless specifically recited in the claims.

The system 1 also preferably contains an air preheater heat exchanger 39 which is adapted to preheat the air inlet stream from the air blower 35 using heat from an anode exhaust stream exiting from the stack anode outlet 31. Preferably, the air blower provides an air inlet stream into the system 1 which comprises at least 2.5 times, such as 2.5 to 6.5 times, preferably 3 to 4.5 times as much air as required for the fuel cell stack 3 to generate electricity. For example, the blower 35 may preheat the air inlet stream to about 50° C. The slightly preheated inlet air stream is then provided from the blower into the air preheater heat exchanger 39 where it is preheated to about 100 to about 150° C., such as about 140° C., for example. This preheated air inlet stream then enters the cathode recuperator heat exchanger 33 at about 100 to about 150° C. and exits the heat exchanger 33 at about 700 to about 750° C., such as about 720° C. Since the preheated air inlet stream enters the cathode recuperator heat exchanger 33 at a temperature above room temperature, the cathode exhaust stream can exit the heat exchanger 33 at a temperature above 200° C. Thus, the air preheater heat exchanger 39 sufficiently preheats the air inlet stream to allow the use of an undersized cathode recuperator heat exchanger 33, which reduces the overall system manufacturing cost.

Preferably, the air preheater 39 is located outside the hot box 37 and upstream of the cathode recuperator 33, such that the air inlet stream is first heated by the anode exhaust stream in the air preheater 39, followed by being heated by the cathode exhaust stream in the cathode recuperator 33. Thus, the air inlet stream provided into the cathode inlet 41 of the stack 3 is heated by both the anode and cathode exhaust streams from the stack 3.

The system 1 optionally contains a water gas shift reactor 43 which is adapted to convert at least a portion of water vapor in the fuel cell stack anode exhaust stream into free hydrogen. Thus, the inlet 45 of the reactor 43 is operatively connected to the stack anode outlet 31, and the outlet 47 of the reactor 43 is operatively connected to an inlet 49 of the air preheater 39. The water-gas shift reactor 43 may be any suitable device which converts at least a portion of the water exiting the fuel cell stack 3 fuel exhaust outlet 31 into free hydrogen. For example, the reactor 43 may comprise a tube or conduit containing a catalyst which converts some or all of the carbon monoxide and water vapor in the anode exhaust stream into carbon dioxide and hydrogen. The catalyst may be any suitable catalyst, such as an iron oxide or a chromium promoted iron oxide catalyst.

The system 1 also optionally contains a condenser 51 adapted to condense water vapor in the anode exhaust stream into liquid water, preferably using an ambient airflow as a heatsink. The system 1 also optionally contains a hydrogen recovery system 53 adapted to recover hydrogen from the anode exhaust stream after the anode exhaust stream passes through the condenser 51. The hydrogen recovery system may be a pressure swing adsorption system or another suitable gas separation system, for example. Preferably, the air preheater 39 partially condenses the water vapor in the anode exhaust stream prior to the anode exhaust stream entering the condenser 51 to reduce the load on the condenser 51. Thus, the outlet 55 of the air preheater 39 is operatively connected to the inlet 57 of the condenser 51. A first outlet 59 of the condenser 51 provides hydrogen and other gases separated from the water to the hydrogen recovery system 53. A second outlet 61 of the condenser 51 provides water to an optional water purification system 63. The water from the purification system 63 is provided to the evaporator 6 which comprises a portion of the heat transfer device 5, through inlet 11.

The system 1 also optionally contains a desulfurizer 65 located in the path of the fuel inlet stream from the fuel source 27. The desulfurizer 65 removes some or all of the sulfur from the fuel inlet stream. The desulfurizer 65 preferably comprises the catalyst, such as Co—Mo or other suitable catalysts, which produces CH₄ and H₂S gases from hydrogenated, sulfur containing natural gas fuel, and a sorbent bed, such as ZnO or other suitable materials, for removing the H₂S gas from the fuel inlet stream. Thus, a sulfur free or reduced sulfur hydrocarbon fuel, such as methane or natural gas, leaves the desulfurizer 65.

A method of operating the system 1 according to a first preferred embodiment of the present invention is described with reference to FIGS. 2 and 3.

The air inlet stream is provided from the air blower 35 into the air preheater 39 through conduit 101. The air inlet stream is preheated in the air preheater 39 by exchanging heat with the anode exhaust stream coming from the water-gas shift reactor 43. The preheated air inlet stream is then provided into the cathode recuperator 33 through conduit 103, where the air inlet stream is heated to a higher temperature by exchanging heat with the cathode exhaust stream. The air inlet stream is then provided into the cathode inlet 41 of the stack 3 through conduit 105.

The air then exits the stack 3 cathode outlet 9 as the cathode exhaust stream. The cathode exhaust stream wraps around the reformer 21 and enters the combustion zone of the combustor 23 through conduit 107 and inlet 25. Desulfurized natural gas or another hydrocarbon fuel is also supplied from the fuel inlet 27 through conduit 109 into the combustor 23 inlet 25 for additional heating. The exhaust stream from the combustor 23 (i.e., cathode exhaust stream) then enters the cathode recuperator through conduit 111 where it exchanges heat with the incoming air.

The cathode exhaust stream is then provided into the evaporator 6 of the heat transfer device 5 through conduit 113. The rest of the heat left in the cathode exhaust stream is then extracted in the evaporator 6 for evaporating water for steam methane reformation before venting out through exhaust conduit 115.

On the fuel side, the hydrocarbon fuel inlet stream enters the desulfurizer 65 from the fuel source 27, such as a gas tank or a valved natural gas pipe. The desulfurized fuel inlet stream (i.e., desulfurized natural gas) then enters the fuel mixer 8 of the heat transfer device 5 through conduit 117. In the mixer 8, the fuel is mixed with purified steam from the evaporator 6.

The steam/fuel mix is then provided into the fuel preheater 29 through conduit 119. The steam/fuel mix is then heated by exchanging heat with the anode exhaust stream in the fuel preheater 29 before entering the reformer through conduit 121. The reformate then enters the stack 3 anode inlet 17 from the reformer 21 through conduit 123.

The stack anode exhaust stream exists the anode outlet 31 and is provided into the fuel preheater 29 through conduit 125, where it heats the incoming fuel/steam mix. The anode exhaust stream from the hot box 37 then enters the water gas shift reactor 43 through conduit 127. The anode exhaust stream from reactor 43 is then provided into the air preheater 39 through conduit 129, where it exchanges heat with the air inlet stream. The anode exhaust stream is then provided into the condenser 51 through conduit 131, where water is removed from the anode exhaust stream and recycled or discharged. For example, the water may be provided into the water purifier 63 through conduit 133, from where it is provided into the evaporator through conduit 135. Alternatively, water may be provided into the purifier 63 through a water inlet 137, such as a water pipe. The hydrogen rich anode exhaust is then provided from the condenser 51 through conduit 139 into the hydrogen purification system 53, where hydrogen is separated from the other gases in the stream. The other gases are purged through purge conduit 141 while hydrogen is provided for other uses or storage through conduit 143.

Thus, as described above, the fluid streams in the system 1 exchange heat in several different locations. The cathode exhaust stream is wrapped around the steam methane reformer 21 to supply the endothermic heat required for reformation. Then, natural gas or other hydrocarbon fuel is added directly to the cathode exhaust stream passing through the combustor 23 as needed to satisfy the overall heat requirement for reformation. Heat from the high-temperature exhaust exiting the combustor 23 (containing the cathode exhaust stream and the combusted fuel components, referred to as “cathode exhaust stream”) is recuperated to the incoming cathode air (i.e., air inlet stream) in the cathode recuperator 33. The heat from the anode exhaust stream exiting the anode side of the fuel cell stack 3 is first recuperated to the incoming anode feed (i.e., the fuel inlet stream) in the fuel preheater 29 and then recuperated to the incoming cathode feed (i.e., the air inlet stream) in the air preheater 39.

Preferably, the air supplied to the fuel cell stack 3 from air blower 35 is provided in excess of the stoichiometric amount required for fuel cell reactions, in order to cool the stack and take away the heat produced by the stack. The typical ratio of air flow to stoichiometric amount is in excess of 4, such as 4.5 to 6, preferably about 5. This leads to substantially higher mass flow of cathode air than anode gas (i.e., fuel). Consequently, if the cathode exhaust stream only heats the air inlet stream, then the amount of heat which is transferred between the cathode exhaust and air inlet streams is significantly higher than that which is transferred between the anode exhaust and fuel inlet streams, typically by a factor of approximately 3.

The present inventors realized that rather than transferring all of the heat which is recaptured from the cathode exhaust stream directly to the incoming air, the system 1 transfers only a portion of the cathode exhaust stream heat to the incoming air inlet stream and uses the remainder of the available cathode exhaust stream heat for complete vaporization of the water in the evaporator 6.

Thus, before the air inlet stream is heated to the appropriate fuel cell temperature, it is preheated by the anode exhaust stream in the air preheater 39. This preheating ensures that the air inlet stream has a sufficiently high temperature when entering the cathode recuperator 33 to ensure that the recuperator 33 can raise the temperature of the air inlet stream to the appropriate fuel cell temperature.

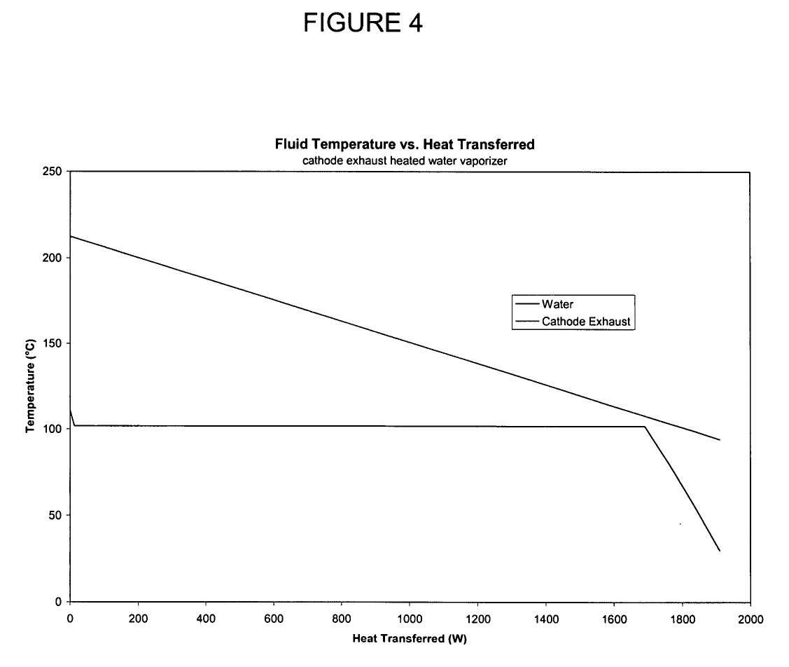

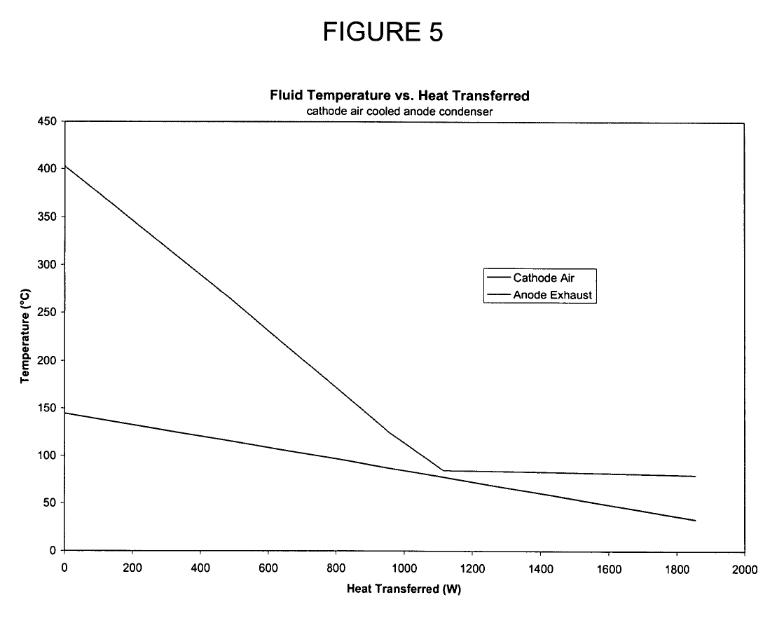

FIGS. 4 and 5 show graphs of the fluid temperature vs. the heat transferred for the evaporator 6 (i.e., the water vaporizer), and the air preheater 39, respectively, for one analyzed embodiment. As can be seen from the graphs in FIGS. 4 and 5, the thermodynamic cross-over shown in FIG. 1 is eliminated. This removes the need for either a humidity exchanger or a supplemental heater which consumes additional fuel.

In a heat exchanger, the “temperature approach” is defined as the smallest temperature difference between the two fluid streams at any location in the heat exchanger. As can be seen in FIGS. 4 and 5, both of the heat exchangers (i.e., the evaporator 6 and the air preheater 39) have a very small temperature approach, located away from either end of the heat exchanger at the point where the two-phase region begins. It is advantageous to maximize the temperature approach in each heat exchanger, since the rate of heat transfer between the fluids will decrease as the local temperature difference between the streams decreases, leading to a need for a larger heat exchanger to transfer the required heat.

If the portion of total cathode air preheat which occurs in the cathode recuperator 33 is decreased, the temperature approach will increase in the evaporator 6. However, the temperature approach will decrease in the air preheater 39. Conversely, if the portion of total cathode air preheat which occurs in the cathode recuperator 33 is increased, the temperature approach will increase in the air preheater 39. However, the temperature approach will decrease in the evaporator 6. Of the total cathode heat duty, there will then be some optimum percentage which should be transferred within the cathode recuperator 33 in order to maximize the temperature approach in both the evaporator 6 and the air preheater 39.

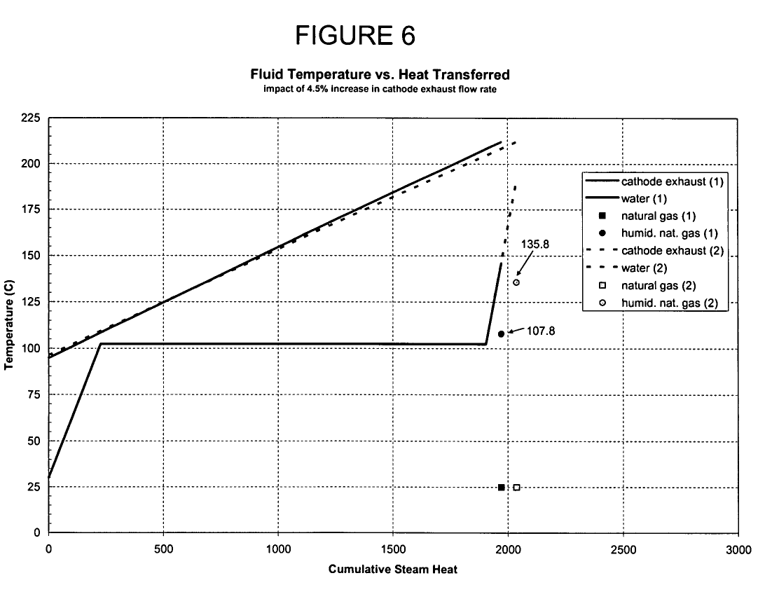

The present inventors also realized that by using the cathode exhaust stream for vaporizing the water, the amount of superheat in the steam exiting the evaporator 6 is very sensitive to the temperature and mass flow rate of the cathode exhaust stream entering the evaporator. This can be seen in FIG. 6, which shows the impact of a 4.5% increase in cathode exhaust stream mass flow (with the cathode exhaust stream temperature into the evaporator remaining unchanged) on the resulting humidified natural gas temperature.

The temperature of the humidified natural gas entering the fuel preheater 29 can be seen to increase by 28° C. due to this slight increase in cathode exhaust stream flow rate. This increase in temperature will result in a higher anode exhaust stream temperature exiting the fuel preheater, and subsequently a higher temperature exiting the water gas shift reactor 43 and entering the air preheater 39. This in turn leads to an increase in the cathode air preheat, which will tend to increase the temperature of the cathode exhaust stream entering the evaporator 6, thereby exacerbating the problem. The humidified natural gas temperature will continue to ratchet up, resulting in system stability problems, unless the inlet air flow rate is controlled. Thus, the cathode air (i.e., inlet air) flow rate needs to be controlled because it is one of the prime means of controlling the system 1.

In a second preferred embodiment, the previously mentioned potential stability problems may be reduced or eliminated by having an adjustable cathode exhaust bypass around the evaporator 6, through which a small portion of the cathode exhaust stream could be diverted in order to control the cathode exhaust flow rate through the evaporator 6. This solution uses active control of the fluid flow rate.

In a third preferred embodiment, a passive approach is used to reduce or eliminate the previously mentioned potential stability problems without the need for additional monitoring and control. The present inventors have realized that a temperature of the humidified natural gas entering the fuel preheater 29 can be made to be relatively insensitive to changes in the cathode exhaust stream flow rate and/or temperature by limiting the potential for increased superheat in the evaporator through a temperature pinch.

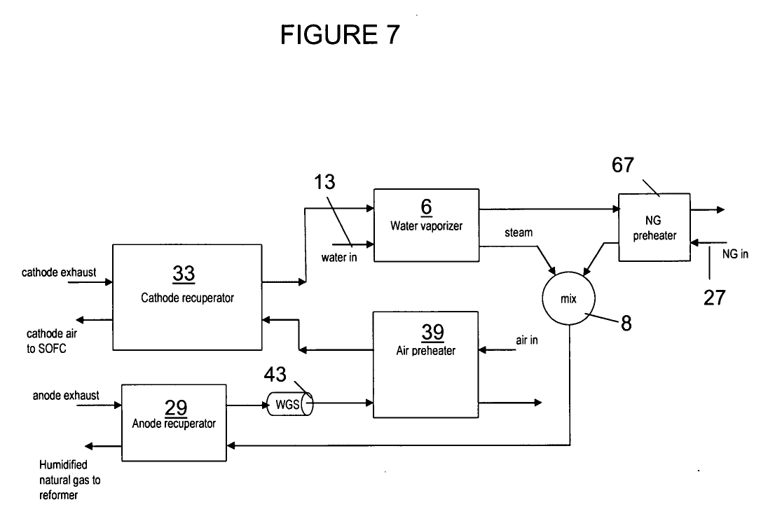

FIG. 7 illustrates the heat exchanger portion of the system of the third preferred embodiment. The other parts of the system of the third preferred embodiment are the same as those of the first preferred embodiment shown in FIGS. 2 and 3.

As shown in FIG. 7, the direction of the water flow through the evaporator 6 is concurrent or parallel (rather than counter current) with the flow of the cathode exhaust stream through the evaporator 6. Rather than having the temperature approach in the evaporator 6 located at the onset of the two-phase flow region, it is shifted to the end of the heat transfer region of the evaporator 6, where the temperature approach will “pinch” to a value of zero or closely approaching zero. No heat transfer between the streams will occur after this point, and the two fluids will exit at or near a common temperature. The cathode exhaust stream flow rate may need to be increased slightly in order to ensure that the heat capacity in the cathode exhaust stream is sufficient to achieve full vapor quality in the water. The water (i.e., steam) will then exit the evaporator 6 with some amount of superheat. The cathode exhaust stream exiting the evaporator 6 can then be used to preheat the fuel, such as natural gas in a second fuel preheater 67. Since the fuel inlet stream has a very small flow rate compared to the cathode exhaust stream, it is quite easy to achieve 100% effective heat transfer and preheat the fuel inlet stream to the same temperature as the water vapor and cathode exhaust stream exiting the evaporator.

Thus, as shown in FIG. 7, the system of the third preferred embodiment also contains the second fuel preheater 67. The fuel preheater 67 includes a first input 69 operatively connected to a cathode exhaust outlet 9 of the fuel cell stack 3, a second input 71 operatively connected to the fuel source 27, and a first output 73 operatively connected to the fuel inlet conduit 17. The second fuel preheater 67 is adapted to transfer heat from the cathode exhaust stream of the fuel cell stack to the fuel inlet stream being provided to the fuel cell stack 3. The evaporator 6 in the third preferred embodiment comprises a concurrent flow or “co-flow” evaporator in which the cathode exhaust stream and the water are adapted to flow in a same direction, and an output of the evaporator is operatively connected to an inlet of the fuel preheater heat exchanger such that the cathode exhaust stream flows from the evaporator 6 into the second fuel preheater 67.

Thus, the water and the cathode exhaust stream are preferably provided into the same side of the evaporator and flow concurrent to each other. The water is converted to steam in the evaporator 6 and is provided into the steam/fuel mixer 8. The cathode exhaust stream is provided from the evaporator into the second fuel preheater heat exchanger 67 where it heats the inlet fuel flow which is then provided through the mixer 8 and the first fuel preheater heat exchanger (anode recuperator 29) into the stack 3.

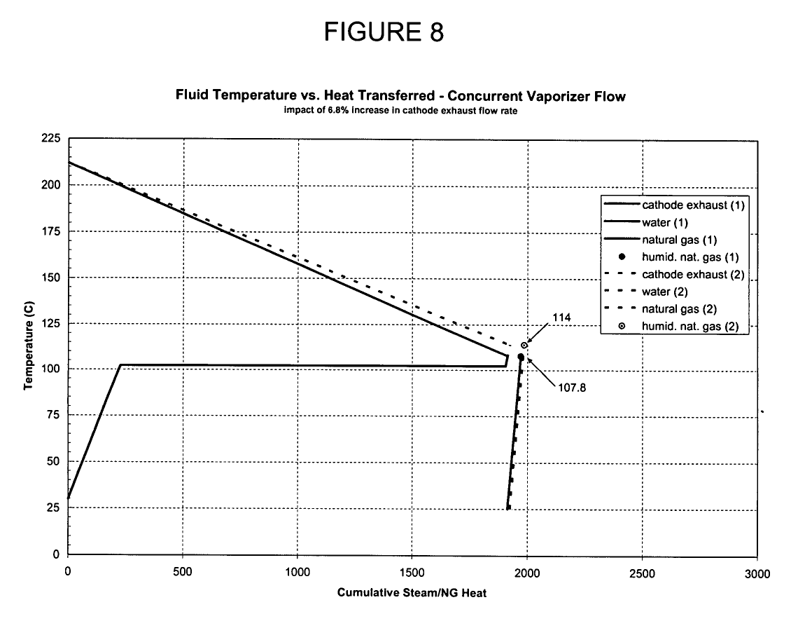

The system of the third preferred embodiment is substantially insensitive to variations in cathode exhaust stream temperature and mass flow. FIG. 8 shows that, for one analyzed embodiment, the humidified natural gas temperature entering the anode recuperator (i.e., first fuel preheater) 29 will increase by less than 7° C. due to a 6.8% increase in cathode exhaust stream mass flow in the system of the third preferred embodiment. Such a small temperature rise should not cause the temperature ratcheting described above, and therefore will result in system stability without the need for active control of the inlet air and/or cathode exhaust stream flow.

Thus, in the preferred embodiments of the present invention, water is evaporated using the heat from cathode exhaust stream. The air heat exchanger (i.e., cathode recuperator) is undersized so that the hot stream exits it at a high temperature of at least 200° C., such as 200 to 230° C. Air is fed into the system at a stoic of 2.5 and above to have enough exhaust heat for evaporating water needed for steam methane reformation. Preferably, between 2.5 and 6.5 times, more preferably between 3 and 4.5 times as much air is provided into the fuel cell stack as required for the fuel cell stack to generate electricity. The inlet air entering the cathode recuperator is preheated in the air preheater using the anode exhaust stream to reduce the load on the cathode recuperator. Water from the anode exhaust stream is partially condensed in the air pre-heater to reduce load in the anode condenser. Additional description of the fuel humidifier 5 is provided in U.S. patent application Ser. Nos. ______, (attorney docket numbers 00655P1268US, 00655P1306US, and 00655P1307US) filed on the same date as the present application, titled “High temperature fuel cell system with integrated heat exchanger network” and naming Jeroen Valensa, Todd M. Bandhauer and Michael J. Reinke as the inventors.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system, comprising:
a fuel cell stack;
a heat transfer device adapted to transfer heat from a cathode exhaust stream of the fuel cell stack to water to be provided to a fuel inlet stream;
a reformer adapted to reform a hydrocarbon fuel to a hydrogen containing reaction product and to provide the reaction product to the fuel cell stack; and
a combustor which is thermally integrated with the reformer.

2. The system of claim 1, wherein the fuel cell stack comprises a solid oxide fuel cell stack.

3. The system of claim 2, further comprising:
a fuel preheater which is adapted to heat the fuel inlet stream using heat from the fuel cell stack anode exhaust stream;
a cathode recuperator heat exchanger which is adapted to heat an air inlet stream using heat from the cathode exhaust stream;
an air preheater heat exchanger which is adapted to preheat the air inlet stream using heat from the anode exhaust stream;
a steam-fuel mixer which is adapted to mix the fuel inlet stream with the steam provided from an evaporator; and
a hot box containing the fuel cell stack, the reformer, the combustor, the fuel preheater and the cathode recuperator.

4. The system of claim 3, further comprising:
a plurality of connecting conduits;
a water gas shift reactor adapted to convert at least a portion of water vapor in the fuel cell stack anode exhaust stream into free hydrogen;
a condenser adapted to condense water vapor in the anode exhaust stream into liquid water; and
a hydrogen recovery system adapted to recover hydrogen from the anode exhaust stream after the anode exhaust stream passes through the condenser.

5. The system of claim 1, further comprising a means for providing between 2.5 and 6.5 times as much air into the fuel cell stack as required for the fuel cell stack to generate electricity.

6. The system of claim 2, further comprising a means for providing between 3 and 4.5 times as much air into the fuel cell stack as required for the fuel cell stack to generate electricity.

7. The system of claim 1, wherein the fuel cell stack cathode exhaust outlet is operatively connected to an inlet of the combustor.

8. A fuel cell system, comprising:
a fuel cell stack;
a first means for evaporating water to steam using heat from a fuel cell stack cathode exhaust stream;
a second means for providing the steam into a fuel inlet stream being directed to the fuel cell stack;
a third means for reforming a hydrocarbon fuel to a hydrogen containing reaction product and for providing the reaction product to the fuel cell stack; and
a fourth means for combusting a fuel and an oxidizer, wherein the fourth means is thermally integrated with the third means.

9. The system of claim 8, wherein the fuel cell stack cathode exhaust outlet is operatively connected to an inlet of the fourth means.

10. The system of claim 8, wherein the fuel cell stack comprises a solid oxide fuel cell stack.

11. The system of claim 8, further comprising a fifth means for providing between 2.5 and 6.5 times as much air into the fuel cell stack as required for the fuel cell stack to generate electricity.

12. A method of operating a fuel cell system, comprising:
operating a fuel cell stack to generate electricity;
evaporating water to steam using heat from a fuel cell stack cathode exhaust stream;
providing the steam into a fuel inlet stream being directed to the fuel cell stack;
reforming the fuel comprising at least one of methane and natural gas in the fuel inlet stream in a reformer;
providing the reformed fuel into the anode inlet of the fuel cell stack;
providing a fuel and an oxidizer into a combustor; and
providing combustion heat from the combustor to the reformer.

13. The method of claim 12, wherein the fuel cell stack comprises a solid oxide fuel cell stack.

14. The method of claim 12, wherein the step of providing an oxidizer into the combustor comprises providing the fuel cell stack cathode exhaust stream into the combustor.

15. The method of claim 12, further comprising transferring heat from the cathode exhaust stream to the reformer by passing the cathode exhaust stream adjacent to the reformer.

16. The method of claim 12, further comprising:
converting at least a portion of water vapor in a fuel cell stack anode exhaust stream into free hydrogen;
condensing the water vapor in the anode exhaust stream into liquid water; and
recovering hydrogen from the anode exhaust stream after the step of condensing.

17. The method of claim 12, further comprising providing between 2.5 and 6.5 times as much air into the fuel cell stack as required for the fuel cell stack to generate electricity.

18. A method of operating a fuel cell system, comprising:
operating a fuel cell stack to generate electricity;
evaporating water to steam using heat from a fuel cell stack cathode exhaust stream;
providing the steam into a fuel inlet stream being directed to the fuel cell stack;
converting at least a portion of water vapor in a fuel cell stack anode exhaust stream into free hydrogen;
condensing the water vapor in the anode exhaust stream into liquid water; and
recovering hydrogen from the anode exhaust stream after the step of condensing.

19. A fuel cell system, comprising:
a fuel cell stack;
a heat transfer device adapted to transfer heat from a cathode exhaust stream of the fuel cell stack to water to be provided to a fuel inlet stream;
a water gas shift reactor adapted to convert at least a portion of water vapor in the fuel cell stack anode exhaust stream into free hydrogen;
a condenser adapted to condense water vapor in the anode exhaust stream into liquid water; and
a hydrogen recovery system adapted to recover hydrogen from the anode exhaust stream after the anode exhaust stream passes through the condenser.

20. The system of claim 19, further comprising:
a reformer adapted to reform a hydrocarbon fuel to a hydrogen containing reaction product and to provide the reaction product to the fuel cell stack; and
a combustor which is thermally integrated with the reformer.
